(19) United States
(12) Patent Application Publication
(10) Pub. No.: US 2024/0259959 A1
(43) Pub. Date: Aug. 1, 2024

(54) DEVICE AND METHOD FOR REPORTING POWER-RELATED INFORMATION

(71) Applicant: FUJITSU LIMITED, Kawasaki-shi Kanagawa (JP)

(72) Inventors: Su YI, Beijing (CN); Lei ZHANG, Beijing (CN); Qinyan JIANG, Beijing (CN); Zhe CHEN, Beijing (CN); Guorong LI, Beijing (CN)

(73) Assignee: FUJITSU LIMITED, Kawasaki-shi Kanagawa (JP)

(21) Appl. No.: 18/632,531

(22) Filed: Apr. 11, 2024

Related U.S. Application Data
(63) Continuation of application No. PCT/CN2021/124114, filed on Oct. 15, 2021.

(51) Int. Cl. H04W 52/36

(52) U.S. Cl. CPC H04W 52/365

(57) ABSTRACT

A device for reporting power-related information, applicable to a first network node, the first network node comprising a first module and a second module, includes: reporting processor circuitry provided in the first module of the first network node and configured to report power-related information of the second module.

### CROSS-REFERENCE TO RELATED APPLICATION

This application is a continuation application of International Application PCT/CN2021/124114, filed on Oct. 15, 2021, and designated the U.S., the entire contents of which are incorporated herein by reference.

### TECHNICAL FIELD

This disclosure relates to the field of communication technologies.

### BACKGROUND

Coverage issue is a fundamental issue in deployment of cellular networks. Mobile operators use different types of network nodes in their deployment to provide comprehensive coverage. A common full protocol stack for cell deployment is ideal, but it is not always feasible (for example, when there is no backhaul link) or economical. Therefore, mobile operators are considering using new types of network nodes to increase flexibility of network deployment.

NR Rel-17 introduces an RF repeater to increase a coverage area of NR cellular network deployment. The RF repeater is usually non-generative, and simply amplifies and forwards (AF) all received signals. The RF repeater is usually full duplex and is unable to distinguish between uplink and downlink transmissions. Its advantages are low cost, simple deployment, and no increase in latency. Its drawback is that it may amplify noises together, thereby increasing interference with the signals.

The NR RF repeater needs to standardize requirements on radio frequencies and electromagnetic compatibility (EMC), as well as consider frequency bands of FR1 (FDD and TDD) and FR2 (TDD). the RF repeater does not need to perform adaptive beamforming on terminal equipments (UEs).

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In order to optimize system performances, including possible interference reduction and further improvement of coverage, a smart repeater is proposed and is considered an effective solution for improving network topology. Main advantages of the smart repeater include a simpler protocol stack compared to conventional relays, IAB-DUs (integrated access and backhaul-distributed units), and gNBs; intelligent operations can be achieved through side control of a gNB, such as dynamically changing transmission and reception (TX/RX) of relays.

A smart repeater can be divided into two parts, one part is used to implement some functions of a UE, which may be referred to as an MT (mobile terminal), and communicates with a network device (such as a gNB). The other part implements a radio frequency function, which is an amplification and forwarding function of a relay, and this part may be referred to as an RU (radio unit).

A link between the gNB and MT is a control link or a control path, and is also a fronthaul link. With this control link, the gNB may configure a smart repeater via side control information, such as TDD configuration, ON/OFF information, and beamforming information of the RU, etc. The control link may be based on an existing Uu interface. The MT applies these configuration information to the RU (i.e. an AF module) via internal operations of the smart repeater.

An access link from the gNB to an ordinary UE undergoes signal amplification and forwarding by the smart repeater, hence it is referred to as an AF link, and may also be referred to as a data path. The repeater is transparent to the UE and the UE is unaware existence of the repeater. The data path (such as FR2) carries analog uplink or downlink signals from or to the UE. This path is essentially an analog signal passthrough. The data path is completely controlled by the gNB (DU) via a control path.

In performing uplink transmission, the UE needs to transmit a power headroom report (PHR) to the network in addition to completing physical layer power control. The power headroom (PH) represents a difference between transmit power in a BWP (bandwidth part) of a current UE and a maximum allowed transmit power capability.

For the power headroom report of the UE, three types of PH are defined in 5G: Type 1 PH is a difference between maximum transmit power of a current terminal and estimated transmit power of a PUSCH (physical uplink shared channel); Type 2 PH is a difference between maximum transmit power of a current terminal and a sum of estimated transmit power of a PUCCH (physical uplink control channel) and a PUSCH; and Type 3 PH is a difference between maximum transmit power of a current terminal and estimated transmit power of an SRS (sounding reference signal).

It was found by the inventors that in a network node of, for example, a smart repeater, etc., a terminal (MT) may only report power headroom of its own in reporting power headroom, and is unable to report power headroom of the RU part. This is not conducive to power control of radio units (RUs) by the network device, thereby affecting performances of the network.

In order to solve one or more of the above problems, embodiments of this disclosure provide a device and method for reporting power-related information. The first module of the first network node reports power-related information of the second module. Hence, the network device is able to perform effective power control on the second module according to the reported power-related information, thereby achieving optimization of network performances.

According to a first aspect of the embodiments of this disclosure, there is provided a device for reporting power-related information, applicable to a first network node, the first network node including a first module and a second module, the device including: a reporting unit provided in the first module of the first network node and configured to report power-related information of the second module.

According to a second aspect of the embodiments of this disclosure, there is provided a device for receiving power-related information, applicable to a network device, the device including: a receiving unit configured to receive power-related information of a second module of a first network node from a first module of the first network node.

According to a third aspect of the embodiments of this disclosure, there is provided a smart repeater, including the device as described in the first aspect of the embodiments of this disclosure.

According to a fourth aspect of the embodiments of this disclosure, there is provided a network device, including the device as described in the second aspect of the embodiments of this disclosure.

According to a fifth aspect of the embodiments of this disclosure, there is provided a communication system, including the smart repeater as described in the third aspect of the embodiments of this disclosure and/or the network device as described in the fourth aspect of the embodiments of this disclosure and a terminal equipment.

According to a sixth aspect of the embodiments of this disclosure, there is provided a method for reporting power-related information, applicable to a first network node, the first network node including a first module and a second module, the method including: reporting power-related information of the second module by the first module of the first network node.

According to a seventh aspect of the embodiments of this disclosure, there is provided a method for receiving power-related information, applicable to a network device, the method including: receiving power-related information of a second module of a first network node by a first module of the first network node.

According to an eighth aspect of the embodiments of this disclosure, there is provided a computer readable program, which, when executed in a device for reporting power-related information or a smart repeater, will cause the device for reporting power-related information or the smart repeater to carry out the method for reporting power-related information as described in the sixth aspect of the embodiments of this disclosure.

According to a ninth aspect of the embodiments of this disclosure, there is provided a computer readable medium, including a computer readable program code, which will cause a device for reporting power-related information or a smart repeater to carry out the method for reporting power-related information as described in the sixth aspect of the embodiments of this disclosure.

According to a tenth aspect of the embodiments of this disclosure, there is provided a computer readable program, which, when executed in a device for receiving power-related information or a network device, will cause the device for receiving power-related information or the network device to carry out the method for receiving power-related information as described in the seventh aspect of the embodiments of this disclosure.

According to an eleventh aspect of the embodiments of this disclosure, there is provided a computer readable medium, including a computer readable program code, which will cause a device for receiving power-related information or a network device to carry out the method for receiving power-related information as described in the seventh aspect of the embodiments of this disclosure.

An advantage of the embodiments of this disclosure exists in that the first module of the first network node reports power-related information of the second module. Hence, the network device is able to perform effective power control on the second module according to the reported power-related information, thereby achieving optimization of network performances.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communication system of an embodiment of this disclosure;

FIG. 2 is a schematic diagram of a first network node of embodiment 1 of this disclosure;

FIG. 3 is a schematic diagram of the method for reporting power-related information of embodiment 1 of this disclosure;

FIG. 4 is a schematic diagram of the smart repeater of embodiment 1 of this disclosure;

FIG. 5 is another schematic diagram of the smart repeater of embodiment 1 of this disclosure;

FIG. 6 is a further schematic diagram of the smart repeater of embodiment 1 of this disclosure;

FIG. 7 is a schematic diagram of embodiment 2 of this disclosure;

FIG. 8 is a schematic diagram of the device for reporting power-related information of embodiment 3 of this disclosure;

FIG. 9 is a schematic diagram of the device for receiving power-related information of embodiment 4 of this disclosure;

FIG. 10 is a block diagram of a systematic structure of the network node of embodiment 5 of this disclosure; and

FIG. 11 is a block diagram of a systematic structure of the network device of embodiment 6 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, “multiple” or “more” refers to at least two.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE)” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

In the embodiments of this disclosure, the term “smart repeater” refers to a relay device, such as a relay device provided in a serving cell to which a network device corresponds, and is used to forward transmitted signals between the network devices and terminal equipments. In addition, it may also be referred to as a repeater, or a repeater node.

Application scenarios of the embodiments of this disclosure shall be described below by way of examples; however, the embodiments of this disclosure are not limited thereto.

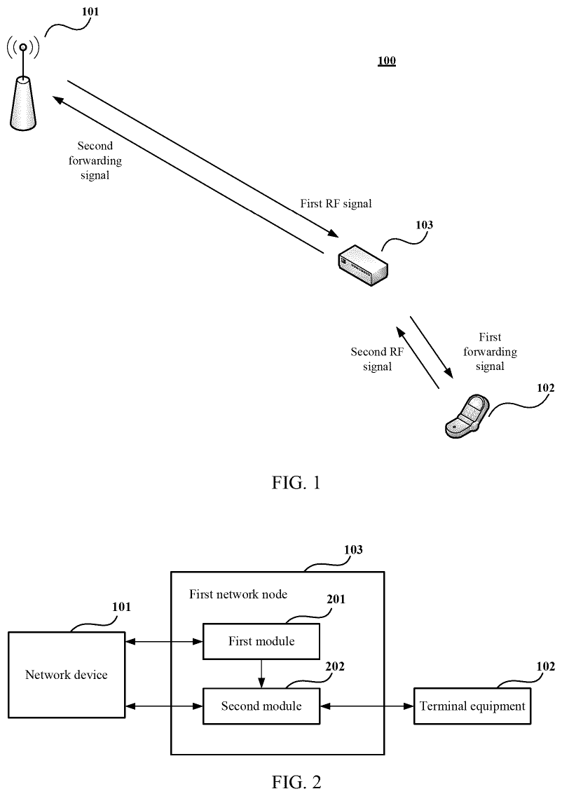

FIG. 1 is schematic diagram of a communication system of an embodiment of this disclosure. As shown in FIG. 1, a communication system 100 may include a network device 101, a terminal equipment 102 and first network node 103.

In the embodiment of this disclosure, existing traffics or traffics that may be implemented in the future may be performed between the network device 101 and the terminal equipment 102. For example, such traffics may include but not limited to enhanced mobile broadband (eMBB), massive machine type communication (mMTC), and ultra-reliable and low-latency communication (URLLC), etc. The first network node 103 is, for example, a smart repeater.

As shown in IG. 1, the first network node 103 receives a first RF signal from the network device 101, obtains a first forwarding signal after amplifying the signal and transmits it to the terminal equipment 102, and/or, the first network node 103 receives a second RF signal from the terminal equipment 102, obtain a second forwarding signal after amplifying the signal and transmits it to the network device 101.

### Embodiment 1

The embodiment of this disclosure provides a method for reporting power-related information, applicable to a first network node.

In the embodiment of this disclosure, the first network node is a node used to improve network coverage or enhance user performances, and is controlled by a network device.

For example, the first network node is a smart repeater, or may also be other nodes, such as a reconfigurable intelligent surface (RIS).

In the embodiment of this disclosure, description shall be given by taking a smart repeater as an example; however, a type of the first network node is not limited in the embodiment of this disclosure.

In the embodiment of this disclosure, the first network node may include a first module and a second module. For example, the first module is a mobile terminal (MT) module, and the second module is a radio unit (RU) module.

FIG. 2 is a schematic diagram of the first network node in embodiment 1 of this disclosure. As shown in FIG. 2, the first network node 103 includes:
a first module 201 configured to communicate with a network device 101; and
a second module 202 configured to amplify and forward a radio frequency signal, such as amplifying and forwarding (AF) radio frequency signals from the network device 101 and/or a terminal equipment 102.

For example, the first module 201 is an MT module, and the second module 202 is an RU module.

In addition, in the embodiment of this disclosure, the first module 201 may apply configuration information or a command obtained from the network device to the amplification and/or forwarding by the second module 202.

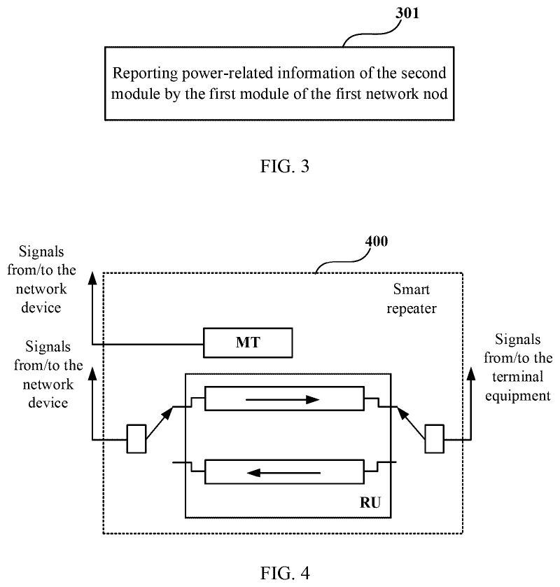

FIG. 3 is a schematic diagram of the method for reporting power-related information in embodiment 1 of this disclosure. As shown in FIG. 3, the method includes:
step 301: reporting power-related information of the second module by the first module of the first network node.

In this way, the first module of the first network node reports the power-related information of the second module to the network device, and the network device may effectively control the power of the second module according to the reported power-related information, thereby realizing optimization of network performances.

In the embodiment of this disclosure, the power-related information may include at least one of power headroom, a gain and transmit power of the second module.

In the embodiment of this disclosure, the power headroom of the second module refers to, for example, a difference between a current maximum transmit power and an estimated value of transmit power.

In the embodiment of this disclosure, the gain of the second module refers to a gain of the second module obtained by amplifying the RF signal. This gain may be referred to as an amplification gain or a repeater gain.

In the embodiment of this disclosure, the transmit power of the second module is power of the second module in transmitting the forwarded and amplified RF signal.

In the embodiment of this disclosure, the power-related information may include uplink power-related information and/or downlink power-related information of the second module.

In the embodiment of this disclosure, as the second module amplifies and forwards both the uplink RF signal and downlink RF signal, there exists corresponding power-related information for both uplink transmission and downlink transmission.

In the embodiment of this disclosure, the uplink power-related information of the second module and the downlink power-related information of the second module may be denoted by the same information, or may be denoted by different information.

For example, the uplink power-related information and downlink power-related information of the second module are denoted by the same power-related information, or the uplink power-related information of the second module is denoted by first power-related information, and the downlink power-related information of the second module is denoted by second power-related information.

In addition, in the embodiment of this disclosure, the uplink power-related information and downlink power-related information of the second module may be reported at the same time, for example, they are included in the same PHR and reported; or, the uplink power-related information and downlink power-related information of the second module may also be reported separately, for example, they are included in different PHRs and reported.

In the embodiment of this disclosure, for example, there is corresponding power headroom for uplink transmission, which may be referred to as uplink power headroom, and there is corresponding power headroom for downlink transmission, which may be referred to as downlink power headroom.

For example, there is a corresponding gain for uplink transmission, which may be referred to as an uplink gain, and there is a corresponding gain for downlink transmission, which may be referred to as a downlink gain.

For example, there is corresponding transmit power for uplink transmission, which may be referred to as uplink transmit power, and there is corresponding transmit power for downlink transmission, which may be referred to as downlink transmit power.

That is, the uplink power-related information may include at least one of the uplink power headroom, uplink gain and uplink transmit power, and the downlink power-related information may include at least one of the downlink power headroom, downlink gain and downlink transmit power.

In the embodiment of this disclosure, the first module may report the power-related information of the first module in addition to reporting the power-related information of the second module (such as the uplink power-related information and/or the downlink power-related information).

In the embodiment of this disclosure, the first module may report the power-related information of the first module and the power-related information of the second module by using identical MAC (media access control) CEs (control elements), or the first module may report the power-related information of the first module and the power-related information of the second module with different MAC CEs.

In the embodiment of this disclosure, the power-related information of the second module may be reported when certain trigger conditions are satisfied.

The followings are details based on reporting the power headroom, gain and transmit power of the second module.

First, reporting the power headroom shall be described in detail.

In the embodiment of this disclosure, for example, the uplink power headroom of the second module is referred to as first power headroom, and the downlink power headroom of the second module is referred to as second power headroom.

The first power headroom and the second power headroom may be power headroom of the same type, or may be power headroom of different types.

For example, the first power headroom is Type 4 power headroom (Type 4 PH), and the second power headroom is Type 5 power headroom (Type 5 PH), or both the first power headroom and second power headroom are Type 4 power headroom (Type 4 PH). In addition, Type 4 power headroom (Type 4 PH) and Type 5 power headroom (Type 5 PH) are just exemplary names, and other names may also be used for the first power headroom and second power headroom to indicate types thereof.

In the embodiment of this disclosure, the first power headroom denotes a difference between a current maximum transmit power of the second module in a frequency band and estimated uplink transmit power, and/or, the second power headroom denotes a difference between the current maximum transmit power of the second module in a frequency band and estimated downlink transmit power.

For example, PH=P_{CMAX}−P_{RU};

where, PH denotes the first power headroom or the second power headroom, P_{CMAX} denotes the current maximum transmit power of the second module in a frequency band, and P_{RU} denotes estimated uplink transmit power or downlink transmit power.

In the embodiment of this disclosure, P_{RU} may be obtained through calculation according to a power control formula, or may be obtained through measurement by the second module at a certain time or period of time. When PH is a positive value, it indicates how much transmit power the second module may use, and when PH is a negative value, it indicates that the calculated transmit power has exceeded maximum allowed transmit power of the second module.

In the embodiment of this disclosure, according to implementation of the second module, “a frequency band” may have different meanings. For example, the first power headroom and/or the second power headroom may be for one cell, or one BWP of a cell, or one carrier, or one pass band.

In this way, with a cell ID, or a BWP ID, or a carrier ID, or a pass band ID, a starting frequency point or center frequency point of the frequency band, as well as a bandwidth, may be reflected.

In the embodiment of this disclosure, in step 301, for example, the first module reports at least one piece of uplink power headroom of the second module and at least one frequency band identifier (ID) to which the uplink power headroom corresponds to a network device, and/or, the first module reports at least one piece of downlink power headroom of the second module and at least one frequency band identifier (ID) to which the downlink power headroom corresponds to the network device.

That is, the first module may report one or more uplink power headrooms and corresponding band ID(s), and/or one or more downlink power headrooms and corresponding band ID(s).

For example, the frequency band ID is a cell ID, or a BWP ID, or a carrier ID, or a pass band ID.

In the embodiment of this disclosure, in step 301, the first module may also report maximum output power (P_{CMAX}) of the second module in at least one band to which the uplink power headroom corresponds to the network device, and/or, the first module may also report maximum output power (P_{CMAX}) of the second module in at least one band to which the downlink power headroom corresponds to the network device.

In step 301, the first module may report the power headroom of the second module via a first MAC CE (control element).

In the embodiment of this disclosure, the first MAC CE may include at least one cell ID and uplink power headroom and/or downlink power headroom to which the cell ID corresponds.

For example, when the second module is allocated one or more cell IDs and these cell IDs do not overlap a cell ID of the first module, the uplink power headroom of the second module may be reported to the network device together with the power headroom of the first module, that is, the power headroom of the first module and the second module may be reported by using an existing PHR MAC CE.

For example, an existing PHR MAC CE of a single entry or multiple entries may remain unchanged, and the network device uses a cell ID to distinguish whether power headroom to which the cell ID corresponds is for the first module or for the second module.

For example, when a cell ID corresponds to the second module, a corresponding entry contains PCMAX and Type 4 PH of the second module.

In the embodiment of this disclosure, the first module may report the power-related information of the first module and the power headroom of the second module with the same MAC CE, and may report the power-related information of the first module and the power headroom of the second module with different MAC CEs.

For example, when the power-related information of the first module and the power headroom of the second module are reported with the same MAC CE, in the MAC CEs, power headroom to which the first cell corresponds is the power headroom of the first module, power headroom to which the second cell corresponds is the power headroom of the second module, and the second cell contains an operating frequency band of the second module. That is, for example, when a reported serving cell contains an operating frequency band of an activated second module (such as an RU), the Type 4 PH of the second module in the operating frequency band may be reported.

In addition, in the embodiment of this disclosure, at least one type of the power headroom of the first module or at least one type of the power headroom of the second module has a priority of reporting. That is, at most one type of power headroom is reported for each serving cell, and which type of power headroom is reported is determined according to a priority of the power headroom, that is, power headroom with a higher priority is reported. Thus, reporting signaling overhead may be lowered.

In the embodiment of this disclosure, it may be that when a first condition is satisfied, the first module of the first network node reports the power headroom of the second module.

For example, the first condition includes at least one of the following conditions that:
the second module is activated or reactivated in a frequency band;
a first timer expires, and at the same time, the first module obtains uplink resources for new data transmission, and after a last time of reporting power headroom, an amount of change of pathloss of at least one serving cell for pathloss reference with an activated downlink BWP that is not a dormant BWP exceeds a first threshold;
a second timer expires;
an RRC layer configures or reconfigures a power headroom report (PHR) function (excluding disabling the PHR) for the first module;
a network side activates a secondary cell (SCell) configured with an uplink BWP having firstActiveDowninkBWP-Id that is not set to be dormant;
a primary secondary cell (PSCell) is added;
the first timer expires, an MAC entity has uplink resources for new data transmission, and any of the activated serving cells of any MAC entity with configured uplink satisfies the following condition: the activated serving cell has uplink resource allocation or PUCCH transmission, and the required power backoff due to power management for the activated serving cell has changed more than a second threshold since the last transmission of a PHR when the MAC entity had uplink resources allocated for transmission or PUCCH transmission on this cell; and
an activated BWP is switched from a dormant BWP to a non-dormant downlink BWP on any secondary cell of the MAC entity configured with uplink.

For example, the first timer may be referred to as a power headroom report prohibit timer (phr-ProhibitTimer), and the second timer may be referred to as a power headroom report periodic timer (phr-PeriodicTimer).

For example, the first threshold is a threshold phr-Tx-PowerFactorChange configured by the network.

In the embodiment of this disclosure, as the second module of the first network node performs uplink and downlink amplification and forwarding, there will also exist power headroom for downlink transmission. The downlink power headroom, i.e. the second power headroom, shall be described below in detail.

In the embodiment of this disclosure, a new type of PH for downlink AF transmission, such as Type 5 PH, may be defined for the second module. The new type of PH denotes a difference between a maximum transmit power of the current second module in a certain frequency band and estimated downlink transmit power. Except for downlink, Type 5 PH is similar to Type 4 PH in terms of other related contents.

In some scenarios, the second module (such as the RU module) will also transmit reference signals of its own, so that the UE performs measurement.

The reference signals may include, for example, at least one of an SSB (synchronization signal block), a CSI-RS (channel state information reference signal), and a downlink SRS.

These signals are generated by the second module itself and are not transmitted via an AF link, and power control used by transmission thereof may also be different.

In the embodiment of this disclosure, different types of power headroom may be defined for the reference signals.

For example, Type 6 PH is defined as a difference between the maximum transmit power of the current second module and estimated transmit power of an SSB, Type 7 PH is defined as a difference between the maximum transmit power of the current second module and estimated transmit power of a CSI-RS, and Type 8 PH is defined as a difference between the maximum transmit power of the current second module and estimated transmit power of a downlink SRS.

In the embodiment of this disclosure, the second power headroom includes actual power headroom and virtual power headroom.

For example, Type 6 PH, Type 7 PH and Type 8 PH may all be divided into real PH and virtual PH. When there is corresponding reference signal transmission, the true PH is reported to the network device, and when there is no corresponding reference signal transmission, a pre-agreed reference signal format is reported to calculate a piece of PH to the network device, which is referred to as virtual PH.

In the embodiment of this disclosure, one or more pieces of downlink PH of the second module and corresponding one or more frequency band IDs may be reported to a base station by the first module of the first network node, such as reporting via an MAC CE. In reporting pH of a certain frequency band, a corresponding P_{CMAX} value of the frequency band may also be included.

In order to lower reporting signaling overhead, at most one type of PH may be reported for each frequency band.

In the embodiment of this disclosure, at least one type of power headroom of the second power headroom of the second module has a priority of reporting, that is, different types of PH of the second power headroom of the second module may be prioritized, and when there are multiple pieces of PH in a certain frequency band, PH with higher priorities are reported according to their priorities.

For example, an order of the priorities is: Type 5 PH>actual Type 6 PH>actual Type 7PH>actual Type 8 PH>virtual Type 6 PH>virtual Type 7 PH>virtual Type 8 PH.

In the embodiment of this disclosure, various modes may be adopted in data transmission of the MT module (the first module) and the RU module (the second module) in the smart repeater. A specific scenario shall be described below by taking that the first network node is a smart repeater as an example.

For example, the MT module and RU module may adopt a mode of frequency division multiplexing (FDM), that is, the MT module and RU module use different carriers.

FIG. 4 is a schematic diagram of the smart repeater of embodiment 1 of this disclosure. As shown in FIG. 4, the smart repeater 400 includes an MT module and an RU module. The MT module and RU module use different carriers, that is, they are in out-of-band communication with each other. There are two radio frequency (RF) chains in the smart repeater, one for the MT module and the other for the RU module. A frequency point at which the RU module operates as an amplifier and a frequency point at which the MT module communicates with the network device are always different, or they are always spaced apart by a sufficient frequency range. In this case, an AF (amplification and forwarding) function part of the smart repeater 400 will not be affected by signals transmitted to or received from the network device by the MT module.

For the smart repeater, the network device also needs to know the uplink transmit power headroom of the RU module, so as to control uplink power of the RU module. As the RU module is a non-autogenous repeater and does not code signals from the UE or network device, the RU module will not learn a physical channel to which the data forwarded by it belong, that is, the three types of PH defined in 5G are not applicable to the PHR of the RU module.

In the embodiment of this disclosure, for example, the power headroom of the RU module reported by the MT module is Type 4 PH, which denotes a difference between maximum transmit power of the current RU module in a certain frequency band and the estimated uplink transmit power. Reference may be made to the above contents regarding uplink power headroom for a specific calculation method, which shall not be repeated here any further.

Likewise, if the uplink power headroom report (PHR) of the RU is triggered, the MT module reports one or more pieces of uplink PH and corresponding frequency band ID(s) of the RU module to the network device. In addition, if the RU module also assigns one or more cell IDs and these cell IDs do not overlap with cell IDs of the MT module, the upstream PH of the RU module may be reported to the network device together with the PH of the MT module, that is, the PH of the MT module and the PH of the RU module are reported by using an existing the PHR MAC CE. The existing PHR MAC CEs of single entry and multiple entries may remain unchanged. The network device may distinguish via a cell ID whether PH to which the cell ID corresponds is for the MT module or the RU module. If a cell ID corresponds to the RU module, a corresponding entry contains PCMAX and Type 4 PH of the RU module.

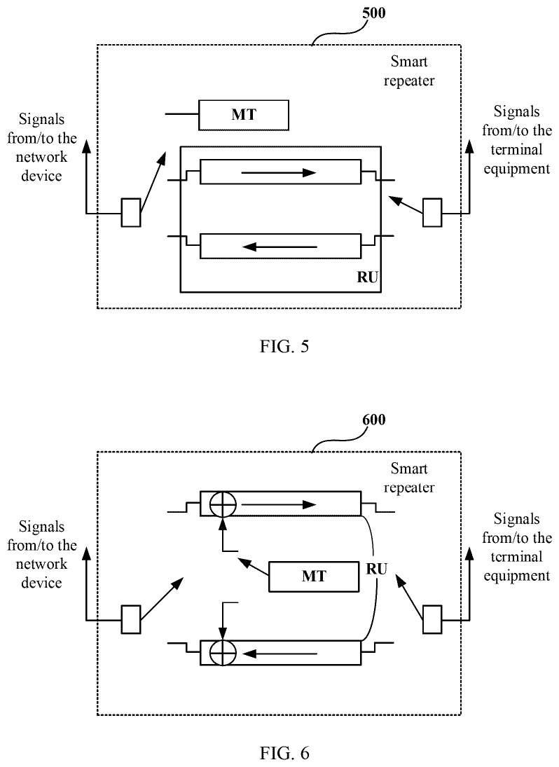

For another example, the MT module and RU module may adopt a mode of time division multiplexing (TDM), that is, the MT module and RU module communicate at different periods of time. FIG. 5 is another schematic diagram of the smart repeater of embodiment 1 of this disclosure. As shown in FIG. 5, the smart repeater 500 includes an MT module and an RU module. The MT module and RU module communicate at different periods of time, and adopt identical frequency bands, that is, they are in in-band communication. In such a structure, when the MT module transmits and receives signals to and from the network device, the RU module will pause or suspend its operations. When the RU module performs amplification and forwarding, the MT module will stop communication.

FIG. 6 is another schematic diagram of the smart repeater of embodiment 1 of this disclosure. As shown in FIG. 6, the smart repeater 600 includes an MT module and an RU module. The MT module and the RU module adopt identical frequency bands, that is, they are in in-band communication; however, the MT module and the RU module do not adopt the transmission mode of time division multiplexing. The uplink or downlink signals of the MT module are combined with the AF signals of the repeater for transmission.

In the scenarios shown in FIGS. 5 and 6, both the MT module and RU module operate at the same frequency band, hence, the PHR MAC CE may be reused for performing PH report, that is, the MT module still uses the PHR MAC CE to report PH related to itself, such as Type 1 PH and Type 3 PH.

However, if a cell contains an operating frequency band of the RU module, the cell may define Type 4 PH for the RU module, and reference may be made to those described above for specific contents of Type 4 PH, which shall not be repeated herein any further.

In addition, as described above, unlike a conventional PHR MAC CE, the MT module may also report the Type 4 PH of the RU module simultaneously. A method is to still use a PHR MAC CE of a single entry or multiple entries. When a reporting serving cell contains an operating frequency band of an active RU module, Type 4 PH of the RU module at the operating frequency band may be reported.

Furthermore, as described above, at least one type of power headroom of the MT module or at least one type of power headroom of the RU module has a priority for reporting. That is, at most one type of power headroom is reported for each serving cell, and power headroom which is reported by the cells is determined according to priorities of the power headroom, that is, power headroom with higher priorities is reported. Thus, signaling overhead of the reporting may be reduced.

For example, for a small cell, if it contains the operating frequency band of the RU module, the power headroom of the MT module may be reported, and the power headroom of the RU module may also be reported; and if the cell does not contain the operating frequency band of the RU module, the power headroom of the MT module is reported. And, in the case where the MT module and RU module have multiple types of power headroom, which power headroom is reported by the cell is determined according to the priorities.

For example, an order of the priorities is: actual Type 1 PH>Type 4 PH>actual Type 3PH>virtual Type 1 PH>virtual Type 3 PH.

Reporting the power headroom is described above in detail. Reporting the gain of the second module shall be described below.

In the embodiment of this disclosure, the first module may report the gain of the second module in at least one frequency band to the network device.

For example, the gain is for a cell, or a BWP of a cell, or a carrier, or a pass band.

For example, the gain of the second module includes an uplink gain and/or a downlink gain of the second module, the uplink gain referring to an amplification gain of uplink transmission, and the downlink gain referring to an amplification gain of downlink transmission.

In the embodiment of this disclosure, the first network node is typically used to enhance cell coverage, hence, a gain used is typically used to compensate for a loss of a path from the network device to the first network node. Therefore, uplink and downlink transmissions may sample identical amplification gains, in which case only one common gain of frequency bands may be reported, indicating that both uplink and downlink use this gain simultaneously.

In the embodiment of this disclosure, the first module may report the gain of the second module via a second MAC CE or RRC signaling.

For example, the second MAC CE is referred to as a GR (gain report) MAC CE.

The RRC signaling is RRC signaling from the first module to the network device.

In the embodiment of this disclosure, the second MAC CE or the RRC signaling may include a frequency band identifier (ID) and an uplink gain and/or a downlink gain corresponding to the frequency band identifier.

In the embodiment of this disclosure, the second MAC CE or the RRC signaling may further include a maximum gain corresponding to the frequency band.

In the embodiment of this disclosure, for example, when a second condition is satisfied, the first module of the first network node reports the gain of the second module.

For example, the second condition includes at least one of the following conditions that:
a third timer expires while the first module obtains an uplink resource for new data transmission, and a change between a gain of the second module in a frequency band and a gain of last power reporting is greater than or equal to a third threshold;
a fourth timer expires; and
an RRC layer configures or reconfigures a gain report (gain report) function (excluding disabling the GR) for the first module.

For example, the third timer may be referred to as a gain report prohibit timer (gr-ProhibitTimer), and the fourth timer may be, for example, referred to as a gain report periodic timer (gr-PeriodicTimer).

In the embodiment of this disclosure, the gain report prohibit timer is a minimum reporting interval set for gain report, that is, the timer is unable to perform gain report during operation, so as to avoid reporting too frequently. The gain report periodic timer is a set maximum reporting interval, that is, even if there are no other events triggered, they need to be reported at a certain period of time.

For example, the third threshold is configured by the network device for the first module via RRC signaling.

Reporting the gain is described above in detail. Reporting the transmit power of the second module shall be described below.

In the embodiment of this disclosure, the reported transmit power may be transmit power of the second module at a certain time, or may be average transmit power of the second module in a certain period of time.

In the embodiment of this disclosure, the transmit power of the second module may include uplink transmit power and/or downlink transmit power of the second module.

In the embodiment of this disclosure, the first module may report the transmit power of the second module via a third MAC CE or RRC signaling.

For example, the third MAC CE is referred to as a PR (power report) MAC CE.

For example, the third MAC CE or RRC signaling includes a frequency band identifier (ID) and uplink transmit power and/or downlink transmit power corresponding to the frequency band identifier. The third MAC CE or RRC signaling may further include maximum transmit power corresponding to the frequency band.

In the embodiment of this disclosure, for example, when a third condition is satisfied, the first module of the first network node reports the transmit power of the second module.

For example, the third condition includes at least one of the following conditions that:
a fifth timer expires while the first module obtains an uplink resource for new data transmission, and a change between transmit power of the second module in a frequency band and transmit power of last power reporting is greater than or equal to a fourth threshold;
a sixth timer expires; and
an RRC layer configures or reconfigures a power report (PR) function (excluding disabling the PR) for the first module.

For example, the fifth timer is referred to as a power report prohibit timer (pr-ProhibitTimer), and the sixth timer is referred to as a power report periodic timer (pr-PeriodicTimer).

For example, the fourth threshold is configured by the network device for the first module via RRC signaling.

It can be seen from the above embodiment that the first module of the first network node reports power-related information of the second module to the network device. Hence, the network device is able to perform effective power control on the second module according to the reported power-related information, thereby achieving optimization of network performances.

### Embodiment 2

Embodiment 2 of this disclosure provides a method for receiving power-related information, applicable to a side of a network device. This method corresponds to the method for reporting power-related information at the side of the first network node in embodiment 1, with identical contents being not going to be repeated herein any further.

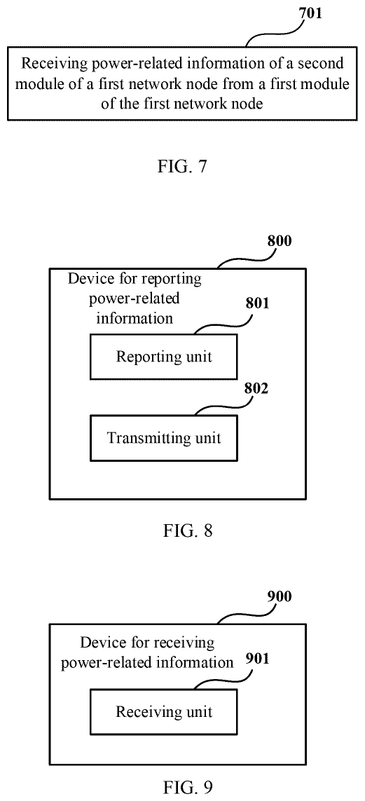

FIG. 7 is a schematic diagram of the method for receiving power-related information in embodiment 2 of this disclosure. As shown in FIG. 7, the method includes:
step 701: receiving power-related information of a second module of a first network node from a first module of the first network node.

For example, the power-related information includes uplink power-related information and/or downlink power-related information of the second module.

For example, the power-related information may include at least one of power headroom, a gain and transmit power of the second module.

For example, the first module is a mobile terminal (MT) module, and the second module is a radio unit (RU) module.

For example, the first network node is a smart repeater (SR).

Reference may be made to what is described in embodiment 1 for implementation of the method and contents regarding the power-related information, which shall not be described here in any further.

It can be seen from the above embodiment that the first module of the first network node reports power-related information of the second module to the network device. Hence, the network device is able to perform effective power control on the second module according to the reported power-related information, thereby achieving optimization of network performances.

### Embodiment 3

Embodiment 3 of this disclosure provides a device for reporting power-related information, applicable to a first network node, the first network node including a first module and a second module. As a principle of the device for solving problems is identical to that of the method in embodiment 1, reference may be made to the implementation of the method in embodiment 1 for implementation of the device, with identical contents being not going to be repeated herein any further.

FIG. 8 is a schematic diagram of the device for reporting power-related information of embodiment 3 of this disclosure. As shown in FIG. 8, a device 800 for reporting power-related information includes:
a reporting unit 801 provided in the first module of the first network node and configured to report power-related information of the second module.

In the embodiment of this disclosure, the power-related information may include uplink power-related information and/or downlink power-related information of the second module.

In the embodiment of this disclosure, the uplink power-related information of the second module and the downlink power-related information of the second module may be denoted by the same information.

In the embodiment of this disclosure, the uplink power-related information and downlink power-related information of the second module may be reported at the same time, or, the uplink power-related information and downlink power-related information of the second module may be reported separately.

In the embodiment of this disclosure, the power-related information may include at least one of power headroom, a gain and transmit power of the second module.

In the embodiment of this disclosure, the power headroom of the second module may include uplink power headroom of the second module and/or downlink power headroom of the second module, the uplink power headroom of the second module being first power headroom, and the downlink power headroom of the second module being second power headroom.

In the embodiment of this disclosure, the first power headroom and the second power headroom may be power headroom of the same type, or may be power headroom of different types.

In the embodiment of this disclosure, the first power headroom denotes a difference between a current maximum transmit power of the second module in a frequency band and estimated uplink transmit power, and/or, the second power headroom denotes a difference between the current maximum transmit power of the second module in a frequency band and estimated downlink transmit power.

In the embodiment of this disclosure, the first power headroom and/or the second power headroom are for one cell, or one BWP of a cell, or one carrier, or one pass band.

In the embodiment of this disclosure, the reporting unit 801 reports at least one piece of uplink power headroom of the second module and at least one frequency band identifier (ID) to which the uplink power headroom corresponds to a network device, and/or, the reporting unit 801 reports at least one piece of downlink power headroom of the second module and at least one frequency band identifier (ID) to which the downlink power headroom corresponds to the network device.

In the embodiment of this disclosure, the reporting unit 801 may also report maximum output power (P_{CMAX}) of the second module in at least one band to which the uplink power headroom corresponds to the network device, and/or, the reporting unit 801 may also report maximum output power (P_{CMAX}) of the second module in at least one band to which the downlink power headroom corresponds to the network device.

In the embodiment of this disclosure, the reporting unit 801 may report the power headroom of the second module via a first MAC CE.

In the embodiment of this disclosure, the first MAC CE may include at least one cell ID and uplink power headroom and/or downlink power headroom to which the cell ID corresponds.

In the embodiment of this disclosure, the device 800 may further include:
a transmitting unit 802 provided in the second module and configured to transmit reference signals,
and for example, the second power headroom denotes a difference between the current maximum transmit power of the second module in a frequency band and estimated transmit power of the reference signals.

For example, the reference signals may include at least one of an SSB, a CSI-RS and a downlink SRS.

In the embodiment of this disclosure, the second power headroom may include actual power headroom and virtual power headroom.

In the embodiment of this disclosure, at least one type of power headroom of the second power headroom of the second module has a priority of reporting.

In the embodiment of this disclosure, the first module may report a gain of the second module in at least one frequency band to the network device.

In the embodiment of this disclosure, the gain is for one cell, or one BWP of a cell, or one carrier, or one pass band.

In the embodiment of this disclosure, the gain of the second module may include an uplink gain and/or a downlink gain of the second module.

In the embodiment of this disclosure, the first module may report the gain of the second module via a second MAC CE or RRC signaling.

In the embodiment of this disclosure, the second MAC CE or the RRC signaling may include a frequency band identifier (ID) and an uplink gain and/or a downlink gain corresponding to the frequency band identifier.

In the embodiment of this disclosure, the second MAC CE or the RRC signaling may further include a maximum gain corresponding to the frequency band.

In the embodiment of this disclosure, the transmit power of the second module may include uplink transmit power and/or downlink transmit power of the second module.

In the embodiment of this disclosure, the reporting unit 801 may report the transmit power of the second module via a third MAC CE or RRC signaling.

In the embodiment of this disclosure, the third MAC CE or RRC signaling may include a frequency band identifier (ID) and uplink transmit power and/or downlink transmit power corresponding to the frequency band identifier.

In the embodiment of this disclosure, the third MAC CE or RRC signaling may further include maximum transmit power corresponding to the frequency band.

In the embodiment of this disclosure, the reporting unit 801 may further report power-related information of the first module.

In the embodiment of this disclosure, the first module may report the power-related information of the first module and the power-related information of the second module with the same MAC CE, or, the first module may report the power-related information of the first module and the power-related information of the second module with different MAC CEs.

In the embodiment of this disclosure, in an MAC CE for reporting power-related information, for example, power headroom to which a first cell corresponds is power headroom of the first module, and power headroom to which a second cell corresponds is power headroom of the second module, the second cell containing an operating frequency band of the second module.

In the embodiment of this disclosure, at least one type of power headroom of the first module or at least one type of power headroom of the second module has a priority for reporting.

In the embodiment of this disclosure, for example, when a first condition is satisfied, the reporting unit reports the power headroom of the second module.

For example, the first condition includes at least one of the following conditions that:
the second module is activated or reactivated in a frequency band;
a first timer expires, and at the same time, the first module obtains uplink resources for new data transmission, and after a last time of reporting power headroom, an amount of change of pathloss of at least one serving cell for pathloss reference with an activated downlink BWP that is not a dormant BWP exceeds a first threshold;
a second timer expires;
an RRC layer configures or reconfigures a power headroom report function for the first module;
a network side activates a secondary cell (SCell) configured with an uplink BWP having firstActiveDowninkBWP-Id that is not set to be dormant;
a primary secondary cell (PSCell) is added;
the first timer expires, an MAC entity has uplink resources for new data transmission, and any of the activated serving cells of any MAC entity with configured uplink satisfies the following condition: the activated serving cell has uplink resource allocation or PUCCH transmission, and the required power backoff due to power management for the activated serving cell has changed more than a second threshold since the last transmission of a PHR when the MAC entity had uplink resources allocated for transmission or PUCCH transmission on this cell; and
an activated BWP is switched from a dormant BWP to a non-dormant downlink BWP on any secondary cell of the MAC entity configured with uplink.

For example, the first timer may be referred to as a power headroom report prohibit timer (phr-ProhibitTimer), and the second timer may be referred to as a power headroom report periodic timer (phr-PeriodicTimer).

In the embodiment of this disclosure, for example, when a second condition is satisfied, the reporting unit reports a gain of the second module.

For example, the second condition includes at least one of the following conditions that: a third timer expires while the first module obtains an uplink resource for new data transmission, and a change between a gain of the second module in a frequency band and a gain of last power reporting is greater than or equal to a third threshold;
a fourth timer expires; and
an RRC layer configures or reconfigures a gain reporting function for the first module.

For example, the third timer may be referred to as a gain report prohibit timer (gr-ProhibitTimer), and the fourth timer may be, for example, referred to as a gain report periodic timer (gr-PeriodicTimer).

For example, the third threshold is configured by the network device for the first module via RRC signaling.

In the embodiment of this disclosure, for example, when a third condition is satisfied, the reporting unit reports transmit power of the second module.

For example, the third condition includes at least one of the following conditions that:
a fifth timer expires while the first module obtains an uplink resource for new data transmission, and a change between transmit power of the second module in a frequency band and transmit power of last power reporting is greater than or equal to a fourth threshold;
a sixth timer expires; and
an RRC layer configures or reconfigures a power report (PR) function (excluding disabling the PR) for the first module.

For example, the fifth timer is referred to as a power report prohibit timer (pr-ProhibitTimer), and the sixth timer is referred to as a power report periodic timer (pr-PeriodicTimer).

For example, the fourth threshold is configured by the network device for the first module via RRC signaling.

In the embodiment of this disclosure, the first module may be a terminal equipment (MT) module, and the second module is a radio unit (RU) module.

In the embodiment of this disclosure, the first network node may be a smart repeater (SR).

It can be seen from the above embodiment that the first module of the first network node reports power-related information of the second module to the network device. Hence, the network device is able to perform effective power control on the second module according to the reported power-related information, thereby achieving optimization of network performances.

### Embodiment 4

Embodiment 4 of this disclosure provides a device for receiving power-related information, applicable to a network device. As a principle of the device for solving problems is identical to that of the method in embodiment 2, reference may be made to the implementation of the method in embodiment 2 for implementation of the device, with identical contents being not going to be repeated herein any further.

FIG. 9 is a schematic diagram of the device for receiving power-related information of embodiment 4 of this disclosure. As shown in FIG. 4, a device 900 for receiving power-related information includes:
a receiving unit 901 configured to receive power-related information of a second module of a first network node from a first module of the first network node.

In the embodiment of this disclosure, the power-related information may include uplink power-related information and/or downlink power-related information of the second module.

In the embodiment of this disclosure, the power-related information may include at least one of power headroom, a gain and transmit power of the second module.

For example, the first module is a mobile terminal (MT) module, and the second module is a radio unit (RU) module.

In the embodiment of this disclosure, the first module may be a terminal equipment (MT) module, and the second module is a radio unit (RU) module.

In the embodiment of this disclosure, the first network node may be a smart repeater (SR).

It can be seen from the above embodiment that the first module of the first network node reports power-related information of the second module to the network device. Hence, the network device is able to perform effective power control on the second module according to the reported power-related information, thereby achieving optimization of network performances.

### Embodiment 5

The embodiment of this disclosure provides a network node, i.e. the above-described first network node, such as a smart repeater, the network node including, for example, the device for reporting power-related information described in embodiment 3.

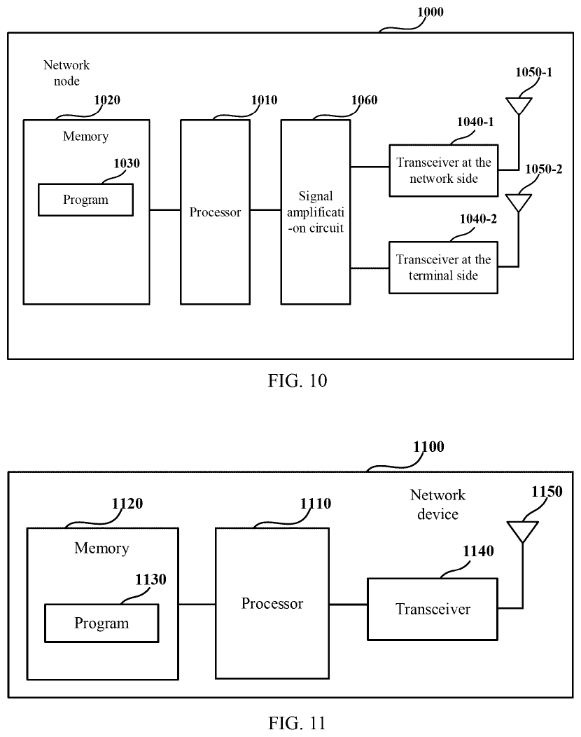

FIG. 10 is a block diagram of a systematic structure of the network node of embodiment 5 of this disclosure. As shown in FIG. 10, a network node 1000 may include a processor 1010 and a memory 1020, the memory 1020 being coupled to the processor 1010. Wherein, the memory 1020 may store various data, and furthermore, it may store a program 1030 for information processing, and execute the program 1030 under control of processor 1010. It should be noted that this figure is illustrative only, and other types of structures may also be used, so as to supplement or replace this structure and achieve a telecommunications function or other functions.

In one implementation, the functions of the device for reporting power-related information may be integrated into the processor 1010. Wherein, the processor 1010 may be configured to report power-related information of a second module by a first module of the first network node.

In another implementation, the device for reporting power-related information and the processor 1010 may be configured separately; for example, the device for reporting power-related information may be configured as a chip connected to the processor 1010, and the functions of the device for reporting power-related information are executed under control of the processor 1010.

As shown in FIG. 10, the network node 1000 may further include a transceiver 1040-1 at the network side and an antenna 1050-1 at the network side, a transceiver 1040-2 at the terminal side and an antenna 1050-2 at the terminal side, and a signal amplification circuit 1060, etc. Wherein, functions of the above components are similar to those in the related art, and shall not be described herein any further. It should be noted that the network node 1000 does not necessarily include all the parts shown in FIG. 10. Furthermore, the network node 1000 may include parts not shown in FIG. 10, and the related art may be referred to.

As shown in FIG. 10, the processor 1010 is sometimes referred to as a controller or an operational control, which may include a microprocessor or other processor devices and/or logic devices. The processor 1010 receives input and controls operations of components of the network node 1000.

Wherein, the memory 1020 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 1010 may execute programs stored in the memory 1020, so as to realize information storage or processing, etc. Functions of other parts are similar to those of the related art, which shall not be described herein any further. The parts of the repeater 1000 may be realized by specific hardware, firmware, software, or any combination thereof, without departing from the scope of this disclosure.

It can be seen from the above embodiment that the first module of the smart repeater reports power-related information of the second module to the network device. Hence, the network device is able to perform effective power control on the second module according to the reported power-related information, thereby achieving optimization of network performances.

### Embodiment 6

The embodiment of this disclosure provides a network device, including the device for receiving power-related information as described in embodiment 4.

FIG. 11 is a schematic diagram of a systematic structure of the network device of embodiment 6 of this disclosure. As shown in FIG. 11, a network device 1100 may include a processor 1110 and a memory 1120, the memory 1120 being coupled to the processor 1110. Wherein, the memory 1120 may store various data, and furthermore, it may store a program 1130 for information processing, and execute the program 1130 under control of the processor 1110, so as to receive various information transmitted by a first network node, and transmit various information to the first network node.

In one implementation, the functions of the device for receiving power-related information may be integrated into the processor 1110. Wherein, the processor 1110 may be configured to receive power-related information of a second module of a first network node from a first module of the first network node.

Furthermore, as shown in FIG. 11, the network device 1100 may include a transceiver 1140, and an antenna 1150, etc. Wherein, functions of the above components are similar to those in the related art, and shall not be described herein any further. It should be noted that the network device 1100 does not necessarily include all the parts shown in FIG. 11, and furthermore, the network device 1100 may include parts not shown in FIG. 11, and the related art may be referred to.

It can be seen from the above embodiment that the first module of the smart repeater reports power-related information of the second module to the network device. Hence, the network device is able to perform effective power control on the second module according to the reported power-related information, thereby achieving optimization of network performances.

### Embodiment 7

The embodiment of this disclosure provides a communication system, including the network node described in embodiment 5 and/or the network device described in embodiment 6.

For example, reference may be made to FIG. 1 for a structure of the communication system. As shown in FIG. 1, the communication system 100 includes a network device 101, a terminal equipment 102 and a first network node 103. The first network node 103 may be identical to the network node described in embodiment 5, and the network device 101 may be identical to the network device described in embodiment 6, with repeated parts being not going to be described herein any further.

It can be seen from the above embodiment that the first module of the smart repeater reports power-related information of the second module to the network device. Hence, the network device is able to perform effective power control on the second module according to the reported power-related information, thereby achieving optimization of network performances.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 8 may either correspond to software modules of procedures of a computer program, or correspond to hardware modules. Such software modules may respectively correspond to the steps shown in FIG. 3. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIG. 8 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 8 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

As to implementations containing the above embodiments, following supplements are further disclosed.

### Supplement I

1. A device for reporting power-related information, applicable to a first network node, the first network node including a first module and a second module,
the device including:
a reporting unit provided in the first module of the first network node and configured to report power-related information of the second module.

2. The device according to supplement 1, wherein,
the power-related information includes uplink power-related information and/or downlink power-related information of the second module.

3. The device according to supplement 2, wherein,
the uplink power-related information of the second module and the downlink power-related information of the second module are denoted by the same information.

4. The device according to supplement 2, wherein,
the uplink power-related information and downlink power-related information of the second module are reported at the same time, or, the uplink power-related information and downlink power-related information of the second module are reported respectively.

5. The device according to any one of supplements 1-4, wherein,
the power-related information includes at least one of power headroom, a gain and transmit power of the second module.

6. The device according to supplement 5, wherein,
the power headroom of the second module includes uplink power headroom of the second module and/or downlink power headroom of the second module,
the uplink power headroom of the second module being first power headroom, and the downlink power headroom of the second module being second power headroom.

7. The device according to supplement 6, wherein,
the first power headroom and the second power headroom are power headroom of the same type, or are power headroom of different types.

8. The device according to supplement 6 or 7, wherein,
the first power headroom denotes a difference between a current maximum transmit power of the second module in a frequency band and estimated uplink transmit power, and/or,
the second power headroom denotes a difference between the current maximum transmit power of the second module in a frequency band and estimated downlink transmit power.

9. The device according to any one of supplements 6-8, wherein,
the first power headroom and/or the second power headroom are for one cell, or one BWP of a cell, or one carrier, or one pass band.

10. The device according to any one of supplements 1-9, wherein,
the reporting unit reports at least one piece of uplink power headroom of the second module and at least one frequency band identifier (ID) to which the uplink power headroom corresponds to a network device, and/or,
the reporting unit reports at least one piece of downlink power headroom of the second module and at least one frequency band identifier (ID) to which the downlink power headroom corresponds to the network device.

11. The device according to supplement 10, wherein,
the reporting unit also reports maximum output power (P_{CMAX}) of the second module in at least one band to which the uplink power headroom corresponds to the network device, and/or,
the reporting unit also reports maximum output power (P_{CMAX}) of the second module in at least one band to which the downlink power headroom corresponds to the network device.

12. The device according to any one of supplements 1-11, wherein,
the reporting unit reports the power headroom of the second module via a first MAC CE.

13. The device according to supplement 12, wherein,
the first MAC CE includes at least one cell ID and uplink power headroom and/or downlink power headroom to which the cell ID corresponds.

14. The device according to supplement 6, wherein the device further includes:
a transmitting unit provided in the second module and configured to transmit reference signals,
and the second power headroom denotes a difference between the current maximum transmit power of the second module in a frequency band and estimated transmit power of the reference signals.

15. The device according to supplement 14, wherein,
the reference signals include at least one of an SSB, a CSI-RS and a downlink SRS.

16. The device according to any one of supplements 6-15, wherein,
the second power headroom includes actual power headroom and virtual power headroom.

17. The device according to any one of supplements 6-16, wherein,
at least one type of power headroom of the second power headroom of the second module has a priority of reporting.

18. The device according to supplement 5, wherein,
the first module reports a gain of the second module in at least one frequency band to the network device.

19. The device according to supplement 18, wherein,
the gain is for one cell, or one BWP of a cell, or one carrier, or one pass band.

20. The device according to supplement 5, wherein,
the gain of the second module includes an uplink gain and/or a downlink gain of the second module.

21. The device according to any one of supplements 5 and 18-20, wherein,
the first module reports the gain of the second module via a second MAC CE or RRC signaling.

22. The device according to supplement 21, wherein,
the second MAC CE or the RRC signaling includes a frequency band identifier (ID) and an uplink gain and/or a downlink gain corresponding to the frequency band identifier.

23. The device according to supplement 22, wherein,
the second MAC CE or the RRC signaling further includes a maximum gain corresponding to the frequency band.

24. The device according to any one of supplements 5 and 18-23, wherein,
the transmit power of the second module includes uplink transmit power and/or downlink transmit power of the second module.

25. The device according to supplement 5 or 24, wherein,
the reporting unit reports the transmit power of the second module via a third MAC CE or RRC signaling.

26. The device according to supplement 25, wherein,
the third MAC CE or RRC signaling includes a frequency band identifier (ID) and uplink transmit power and/or downlink transmit power corresponding to the frequency band identifier.

27. The device according to supplement 26, wherein,
the third MAC CE or RRC signaling further includes maximum transmit power corresponding to the frequency band.

28. The device according to any one of supplements 1-27, wherein,
the reporting unit further reports power-related information of the first module.

29. The device according to supplement 28, wherein,
the first module reports the power-related information of the first module and the power-related information of the second module with the same MAC CE, or,
the first module reports the power-related information of the first module and the power-related information of the second module with different MAC CEs.

30. The device according to any one of supplements 1-29, wherein,
in an MAC CE for reporting power-related information, power headroom to which a first cell corresponds is power headroom of the first module, and power headroom to which a second cell corresponds is power headroom of the second module,
and the second cell includes an operating frequency band of the second module.

31. The device according to supplement 30, wherein,
at least one type of power headroom of the first module or at least one type of power headroom of the second module has a priority for reporting.

32. The device according to any one of supplements 1-31, wherein,
when a first condition is satisfied, the reporting unit reports power headroom of the second module.

33. The device according to supplement 32, wherein the first condition includes at least one of the following conditions that:
the second module is activated or reactivated in a frequency band;
a first timer expires, and at the same time, the first module obtains uplink resources for new data transmission, and after a last time of reporting power headroom, an amount of change of pathloss of at least one serving cell for pathloss reference with an activated downlink BWP that is not a dormant BWP exceeds a first threshold;
a second timer expires;
an RRC layer configures or reconfigures a power headroom report function for the first module;
a network side activates a secondary cell (SCell) configured with an uplink BWP having firstActiveDowninkBWP-Id that is not set to be dormant;
a primary secondary cell (PSCell) is added;
the first timer expires, an MAC entity has uplink resources for new data transmission, and any of the activated serving cells of any MAC entity with configured uplink satisfies the following condition: the activated serving cell has uplink resource allocation or PUCCH transmission, and the required power backoff due to power management for the activated serving cell has changed more than a second threshold since the last transmission of a PHR when the MAC entity had uplink resources allocated for transmission or PUCCH transmission on this cell; and
an activated BWP is switched from a dormant BWP to a non-dormant downlink BWP on any secondary cell of the MAC entity configured with uplink.

34. The device according to supplement 33, wherein,
the first timer is referred to as a power headroom report prohibit timer (phr-ProhibitTimer),
and the second timer is referred to as a power headroom report periodic timer (phr-PeriodicTimer).

35. The device according to any one of supplements 1-31, wherein,
when a second condition is satisfied, the reporting unit reports a gain of the second module.

36. The device according to supplement 35, wherein the second condition includes at least one of the following conditions that:
a third timer expires while the first module obtains an uplink resource for new data transmission, and a change between a gain of the second module in a frequency band and a gain of last power reporting is greater than or equal to a third threshold;
a fourth timer expires; and
an RRC layer configures or reconfigures a gain reporting function for the first module.

37. The device according to supplement 36, wherein,
the third timer is referred to as a gain report prohibit timer (gr-ProhibitTimer),
and the fourth timer is referred to as a gain report periodic timer (gr-PeriodicTimer).

38. The device according to supplement 36, wherein,
the third threshold is configured by the network device for the first module via RRC signaling.

39. The device according to any one of supplements 1-31, wherein,
when a third condition is satisfied, the reporting unit reports transmit power of the second module.

40. The device according to supplement 39, wherein,
the third condition includes at least one of the following conditions that:
a fifth timer expires while the first module obtains an uplink resource for new data transmission, and a change between transmit power of the second module in a frequency band and transmit power of last power reporting is greater than or equal to a fourth threshold;
a sixth timer expires; and
an RRC layer configures or reconfigures a power report (PR) function for the first module.

41. The device according to supplement 40, wherein,
the fifth timer is referred to as a power report prohibit timer (pr-ProhibitTimer),
and the sixth timer is referred to as a power report periodic timer (pr-PeriodicTimer).

42. The device according to supplement 40, wherein,
the fourth threshold is configured by the network device for the first module via RRC signaling.

43. The device according to any one of supplements 1-42, wherein,
the first module is a terminal equipment (MT) module, and the second module is a radio unit (RU) module.

44. The device according to any one of supplements 1-43, wherein,
the first network node is a smart repeater (SR).

45. A device for receiving power-related information, applicable to a network device, the device including:
a receiving unit configured to receive power-related information of a second module of a first network node from a first module of the first network node.

46. The device according to supplement 45, wherein,
the power-related information includes uplink power-related information and/or downlink power-related information of the second module.

47. The device according to supplement 45 or 46, wherein,
the power-related information includes at least one of power headroom, a gain and transmit power of the second module.

48. The device according to any one of supplements 45-47, wherein,
the first module is a mobile terminal (MT) module, and the second module is a radio unit (RU) module.

49. The device according to any one of supplements 45-48, wherein,
the first network node is a smart repeater (SR).

50. A network node, including the device as described in any one of supplements 1-44.

51. A network device, including the device as described in any one of supplements 45-49.

52. A communication system, including:
the network node as described in supplement 50 and/or the network device as described in supplement 51 and a terminal equipment.

### Supplement II

1. A method for reporting power-related information, applicable to a first network node, the first network node including a first module and a second module,
the method including:
reporting power-related information of the second module by the first module of the first network node.

2. The method according to supplement 1, wherein,
the power-related information includes uplink power-related information and/or downlink power-related information of the second module.

3. The method according to supplement 2, wherein,
the uplink power-related information of the second module and the downlink power-related information of the second module are denoted by the same information.

4. The method according to supplement 2, wherein,
the uplink power-related information and downlink power-related information of the second module are reported at the same time, or, the uplink power-related information and downlink power-related information of the second module are reported respectively.

5. The method according to any one of supplements 1-4, wherein,
the power-related information includes at least one of power headroom, a gain and transmit power of the second module.

6. The method according to supplement 5, wherein,
the power headroom of the second module includes uplink power headroom of the second module and/or downlink power headroom of the second module,
the uplink power headroom of the second module being first power headroom, and the downlink power headroom of the second module being second power headroom.

7. The method according to supplement 6, wherein,
the first power headroom and the second power headroom are power headroom of the same type, or are power headroom of different types.

8. The method according to supplement 6 or 7, wherein,
the first power headroom denotes a difference between a current maximum transmit power of the second module in a frequency band and estimated uplink transmit power, and/or,
the second power headroom denotes a difference between the current maximum transmit power of the second module in a frequency band and estimated downlink transmit power.

9. The method according to any one of supplements 6-8, wherein,
the first power headroom and/or the second power headroom are for one cell, or one BWP of a cell, or one carrier, or one pass band.

10. The method according to any one of supplements 1-9, wherein,
the first module reports at least one piece of uplink power headroom of the second module and at least one frequency band identifier (ID) to which the uplink power headroom corresponds to a network method, and/or,
the first module reports at least one piece of downlink power headroom of the second module and at least one frequency band identifier (ID) to which the downlink power headroom corresponds to the network method.

11. The method according to supplement 10, wherein,
the first module also reports maximum output power (P_{CMAX}) of the second module in at least one band to which the uplink power headroom corresponds to the network method, and/or,
the first module also reports maximum output power (P_{CMAX}) of the second module in at least one band to which the downlink power headroom corresponds to the network method.

12. The method according to any one of supplements 1-11, wherein,
the first module reports the power headroom of the second module via a first MAC CE.

13. The method according to supplement 12, wherein,
the first MAC CE includes at least one cell ID and uplink power headroom and/or downlink power headroom to which the cell ID corresponds.

14. The method according to supplement 6, wherein the method further includes:
transmitting reference signals by the second module,
and the second power headroom denotes a difference between the current maximum transmit power of the second module in a frequency band and estimated transmit power of the reference signals.

15. The method according to supplement 14, wherein,
the reference signals include at least one of an SSB, a CSI-RS and a downlink SRS.

16. The method according to any one of supplements 6-15, wherein,
the second power headroom includes actual power headroom and virtual power headroom.

17. The method according to any one of supplements 6-16, wherein,
at least one type of power headroom of the second power headroom of the second module has a priority of reporting.

18. The method according to supplement 5, wherein,
the first module reports a gain of the second module in at least one frequency band to the network method.

19. The method according to supplement 18, wherein,
the gain is for one cell, or one BWP of a cell, or one carrier, or one pass band.

20. The method according to supplement 5, wherein,
the gain of the second module includes an uplink gain and/or a downlink gain of the second module.

21. The method according to any one of supplements 5 and 18-20, wherein,
the first module reports the gain of the second module via a second MAC CE or RRC signaling.

22. The method according to supplement 21, wherein,
the second MAC CE or the RRC signaling includes a frequency band identifier (ID) and an uplink gain and/or a downlink gain corresponding to the frequency band identifier.

23. The method according to supplement 22, wherein,
the second MAC CE or the RRC signaling further includes a maximum gain corresponding to the frequency band.

24. The method according to any one of supplements 5 and 18-23, wherein,
the transmit power of the second module includes uplink transmit power and/or downlink transmit power of the second module.

25. The method according to supplement 5 or 24, wherein,
the first module reports the transmit power of the second module via a third MAC CE or RRC signaling.

26. The method according to supplement 25, wherein,
the third MAC CE or RRC signaling includes a frequency band identifier (ID) and uplink transmit power and/or downlink transmit power corresponding to the frequency band identifier.

27. The method according to supplement 26, wherein,
the third MAC CE or RRC signaling further includes maximum transmit power corresponding to the frequency band.

28. The method according to any one of supplements 1-27, wherein,
the first module further reports power-related information of the first module.

29. The method according to supplement 28, wherein,
the first module reports the power-related information of the first module and the power-related information of the second module with the same MAC CE, or,
the first module reports the power-related information of the first module and the power-related information of the second module with different MAC CEs.

30. The method according to any one of supplements 1-29, wherein,
in an MAC CE for reporting power-related information, power headroom to which a first cell corresponds is power headroom of the first module, and power headroom to which a second cell corresponds is power headroom of the second module,
and the second cell includes an operating frequency band of the second module.

31. The method according to supplement 30, wherein,
at least one type of power headroom of the first module or at least one type of power headroom of the second module has a priority for reporting.

32. The method according to any one of supplements 1-31, wherein,
when a first condition is satisfied, the reporting unit reports power headroom of the second module.

33. The method according to supplement 32, wherein the first condition includes at least one of the following conditions that:
the second module is activated or reactivated in a frequency band;
a first timer expires, and at the same time, the first module obtains uplink resources for new data transmission, and after a last time of reporting power headroom, an amount of change of pathloss of at least one serving cell for pathloss reference with an activated downlink BWP that is not a dormant BWP exceeds a first threshold;
a second timer expires;
an RRC layer configures or reconfigures a power headroom report function for the first module;
a network side activates a secondary cell (SCell) configured with an uplink BWP having firstActiveDowninkBWP-Id that is not set to be dormant;
a primary secondary cell (PSCell) is added;
the first timer expires, an MAC entity has uplink resources for new data transmission, and any of the activated serving cells of any MAC entity with configured uplink satisfies the following condition: the activated serving cell has uplink resource allocation or PUCCH transmission, and the required power backoff due to power management for the activated serving cell has changed more than a second threshold since the last transmission of a PHR when the MAC entity had uplink resources allocated for transmission or PUCCH transmission on this cell; and
an activated BWP is switched from a dormant BWP to a non-dormant downlink BWP on any secondary cell of the MAC entity configured with uplink.

34. The method according to supplement 33, wherein,
the first timer is referred to as a power headroom report prohibit timer (phr-ProhibitTimer),
and the second timer is referred to as a power headroom report periodic timer (phr-PeriodicTimer).

35. The method according to any one of supplements 1-31, wherein,
when a second condition is satisfied, the first module of the first network node reports a gain of the second module.

36. The method according to supplement 35, wherein the second condition includes at least one of the following conditions that:
a third timer expires while the first module obtains an uplink resource for new data transmission, and a change between a gain of the second module in a frequency band and a gain of last power reporting is greater than or equal to a third threshold;
a fourth timer expires; and
an RRC layer configures or reconfigures a gain reporting function for the first module.

37. The method according to supplement 36, wherein,
the third timer is referred to as a gain report prohibit timer (gr-ProhibitTimer),
and the fourth timer is referred to as a gain report periodic timer (gr-PeriodicTimer).

38. The method according to supplement 36, wherein,
the third threshold is configured by the network method for the first module via RRC signaling.

39. The method according to any one of supplements 1-31, wherein,
when a third condition is satisfied, the reporting unit reports transmit power of the second module.

40. The method according to supplement 39, wherein,
the third condition includes at least one of the following conditions that:
a fifth timer expires while the first module obtains an uplink resource for new data transmission, and a change between transmit power of the second module in a frequency band and transmit power of last power reporting is greater than or equal to a fourth threshold;
a sixth timer expires; and
an RRC layer configures or reconfigures a power report (PR) function for the first module.

41. The method according to supplement 40, wherein,
the fifth timer is referred to as a power report prohibit timer (pr-ProhibitTimer),
and the sixth timer is referred to as a power report periodic timer (pr-PeriodicTimer).

42. The method according to supplement 40, wherein,
the fourth threshold is configured by the network method for the first module via RRC signaling.

43. The method according to any one of supplements 1-42, wherein,
the first module is a terminal equipment (MT) module, and the second module is a radio unit (RU) module.

44. The method according to any one of supplements 1-43, wherein,
the first network node is a smart repeater (SR).

45. A method for receiving power-related information, applicable to a network method, the method including:
receiving power-related information of a second module of a first network node from a first module of the first network node.

46. The method according to supplement 45, wherein,
the power-related information includes uplink power-related information and/or downlink power-related information of the second module.

47. The method according to supplement 45 or 46, wherein,
the power-related information includes at least one of power headroom, a gain and transmit power of the second module.

48. The method according to any one of supplements 45-47, wherein,
the first module is a mobile terminal (MT) module, and the second module is a radio unit (RU) module.

49. The method according to any one of supplements 45-48, wherein,
the first network node is a smart repeater (SR).

1. A device for reporting power-related information, applicable to a first network node, the first network node comprising a first module and a second module,
the device comprising:
reporting processor circuitry provided in the first module of the first network node and configured to report power-related information of the second module.

2. The device according to claim 1, wherein,
the power-related information comprises uplink power-related information and/or downlink power-related information of the second module.

3. The device according to claim 1, wherein,
the power-related information comprises at least one of power headroom, a gain and transmit power of the second module.

4. The device according to claim 3, wherein,
the power headroom of the second module comprises uplink power headroom of the second module and/or downlink power headroom of the second module,
the uplink power headroom of the second module being first power headroom, and the downlink power headroom of the second module being second power headroom.

5. The device according to claim 4, wherein,
the first power headroom denotes a difference between a current maximum transmit power of the second module in a frequency band and estimated uplink transmit power, and/or,
the second power headroom denotes a difference between the current maximum transmit power of the second module in a frequency band and estimated downlink transmit power.

6. The device according to claim 4, wherein,
the first power headroom and/or the second power headroom are for one cell, or one BWP of a cell, or one carrier, or one pass band.

7. The device according to claim 1, wherein,
the reporting processor circuitry reports at least one piece of uplink power headroom of the second module and at least one frequency band identifier (ID) to which the uplink power headroom corresponds to a network device, and/or,
the reporting processor circuitry reports at least one piece of downlink power headroom of the second module and at least one frequency band identifier (ID) to which the downlink power headroom corresponds to the network device.

8. The device according to claim 1, wherein,
the reporting processor circuitry reports the power headroom of the second module via a first media access control (MAC) control element (CE).

9. The device according to claim 4, wherein the device further comprises:
a transmitter provided in the second module and configured to transmit reference signals,
and the second power headroom denotes a difference between the current maximum transmit power of the second module in a frequency band and estimated transmit power of the reference signals.

10. The device according to claim 9, wherein,
the reference signals comprise at least one of a synchronization signal block (SSB), a channel state information reference signal (CSI-RS) and a downlink sounding reference signal (SRS).

11. The device according to claim 3, wherein,
the first module reports a gain of the second module in at least one frequency band to the network device.

12. The device according to claim 11, wherein,
the gain is for one cell, or one bandwidth part (BWP) of a cell, or one carrier, or one pass band.

13. The device according to claim 3, wherein,
the first module reports the gain of the second module via a second MAC CE or radio resource control (RRC) signaling.

14. The device according to claim 13, wherein,
the second MAC CE or the RRC signaling comprises a frequency band identifier (ID) and an uplink gain and/or a downlink gain corresponding to the frequency band identifier.

15. The device according to claim 1, wherein,
the reporting processor circuitry further reports power-related information of the first module.

16. The device according to claim 1, wherein,
in an MAC CE for reporting power-related information, power headroom to which a first cell corresponds is power headroom of the first module, and power headroom to which a second cell corresponds is power headroom of the second module,
and the second cell comprises an operating frequency band of the second module.

17. The device according to claim 16, wherein,
at least one type of power headroom of the first module or at least one type of power headroom of the second module has a priority for reporting.

18. The device according to claim 1, wherein,
when a second condition is satisfied, the reporting processor circuitry reports a gain of the second module.

19. The device according to claim 18, wherein the second condition comprises at least one of the following conditions that:
a third timer expires while the first module obtains an uplink resource for new data transmission, and a change between a gain of the second module in a frequency band and a gain of last power reporting is greater than or equal to a third threshold;
a fourth timer expires; and
an RRC layer configures or reconfigures a gain reporting function for the first module.

20. The device according to claim 1, wherein,
the first module is a terminal equipment (MT) module, and the second module is a radio unit (RU) module.
